(19) United States
(12) Patent Application Publication
(10) Pub. No.: US 2024/0362482 A1
(43) Pub. Date: Oct. 31, 2024

(54) AUDITING SYSTEM FOR BUILT ENVIRONMENT OF AGE-FRIENDLY STREET BASED ON MULTISOURCE BIG DATA

(71) Applicant: TONGJI UNIVERSITY, Shanghai (CN)

(72) Inventors: Yifan YU, Shanghai (CN); Liu LIU, Jiangsu (CN); Ye ZHAN, Shanghai (CN); Ding ZHANG, Jiangsu (CN); Yu JIAO, Shanghai (CN); Ye YU, Shanghai (CN)

(73) Assignee: TONGJI UNIVERSITY, Shanghai (CN)

(21) Appl. No.: 18/685,234

(22) PCT Filed: Jan. 9, 2023
(86) PCT No.: PCT/CN2023/071296

§ 371 Date: Feb. 21, 2024

(30) Foreign Application Priority Data
Jan. 28, 2022 (CN) 202210105052.X

(51) Int. Cl. G06N 3/08

(52) U.S. Cl. CPC G06N 3/08

(57) ABSTRACT

The present invention relates to an auditing system for a built environment of an age-friendly street based on multisource big data. The auditing system includes: a data acquisition module is configured to acquire urban streetscape image data, urban road network data and urban point-of-interest data; a data classification auditing module is configured to acquire the data of the data acquisition module, classify the image data, and process the image data by using a data processing method to acquire evaluated numerical values of different types of indexes; a data summary analysis module is configured to acquire the evaluated numerical values of the data classification auditing module, calculate sub-item index numerical values of each output unit and calculate result data according to the sub-item index numerical values; a audit result output module is configured to acquire the result data of the data summary analysis module and visualize and output the result data.

### FIELD OF TECHNOLOGY

The present invention relates to the technical field of auditing of urban built environments, and particularly relates to an auditing system for built environment of age-friendly street based on multisource big data.

### BACKGROUND

Age-friendliness concerns a demand of weak elder populations restricted by a built environment in a city on space quality. Many existing studies have uncovered that the health level of the elder populations profits from health behaviors participated by the elder populations and support given by the environment to a great extent. As far as the old is concerned, thanks to characteristics of somatic functions and social and economic attributes, the activity space of the old is quite limited. Walking is the major trip mode for the old. Walking activities play a significant positive role in promoting the health of the old while communities (especially streets) are the major carrier spaces for the walking activities of the old. Many existing studies have shown that to improve objective characteristics of the built environment such as street walkability, road connectivity, diversity of fields of activities and facility reachability has a positive influence in promoting walking behaviors of the old. As a whole, the street is the important public space where the old participates in social life. As far as the old is concerned, an affectional tie has been established between the old and the community environment while the demand on daily life has been met in the street. A good perception of affiliation and consciousness of community facilitate the old to participate the social activities, which improves the physical and psychological health and the happiness of the old.

In a process of improving the age-friendliness of the urban street environment comprehensively, first, the built environment condition of the street is structurally audited inevitably. In recent years, environment auditing applications based on fields in the field of built environment audit increase rapidly mainly because of surge of interest of people on relationships research between the built environment and a series of health-related behaviors (for example, physical activities, walking, riding and the like). The auditing modes for built communities internationally vary and can be specifically divided into on-the-spot audit and online audit. An object in the built environment audit is an independent element in the environment. For many auditing tools in early stage, auditors are required to walk or drive through a community, a park or a road for encoded recording of the characteristics of the built environment systematically with an existing standard template, so that influence of micro built environment elements (for example, street furniture, a tree, a sidewalk width and the like) on direct space perception is recorded conveniently. In this conventional auditing method, the auditors need to be trained professionally, and are required to observe and record on the spot. This kind of auditing methods is mostly dependent on manpower, so that the methods are time-consuming and low in efficiency, and the applicable auditing range is greatly limited.

### SUMMARY

To overcome the defects in the prior art, an object of the present invention is to provide an auditing system for a built environment of an age-friendly street based on multisource big data.

The object of the present invention can be realized by the technical solution as follows:

An auditing system for a built environment of an age-friendly street based on multisource big data includes a data acquisition module, a data classification auditing module, a data summary analysis module and an audit result output module, where
the data acquisition module is configured to acquire urban streetscape image data, urban road network data and urban point-of-interest data in a target range, wherein the urban streetscape image data comprises image data;
the data classification auditing module is configured to acquire the data of the data acquisition module, and acquire evaluated numerical values of different types of indexes by means of a corresponding data processing method;
the data summary analysis module is configured to acquire the evaluated numerical values of the data classification auditing module, calculate sub-item index numerical values of each output unit and calculate result data according to the sub-item index numerical values; and
the audit result output module is configured to acquire the result data of the data summary analysis module and visualize and output the result data in combination with the urban road network data and the urban point-of-interest data.

Further, after acquiring the image data, the data classification auditing module classifies the image data according to a four-layer classification module to acquire a classification result of the image data, and acquires a data processing method corresponding to the image in combination with an existing auditing index classification table according to the classification result.

Further, the data processing method of the data classification auditing module includes object detection and identification, object semantic segmentation, place perception analysis and geographic space data analysis.

Further, the object detection and identification includes: inputting an image into an object detection model to obtain an evaluated numerical value; and
a training process of the object detection model includes:
S1: acquiring an evaluated training image with calibrated evaluation information and pre-processing the calibrated evaluation information;
S2: extracting a characteristic of the evaluated training image by using a first YOLOv5 network model; and
S3: calculating a loss function according to the characteristic and the pre-processed calibrated evaluation information, training the first YOLOv5 network model through back propagation according to the loss function, and finally, obtaining the object detection model.

Further, the object semantic segmentation includes: inputting an image into an object semantic model to obtain an evaluated numerical value; and
a training process of the object semantic model includes:
A1: acquiring an evaluated training image with calibrated evaluation information to generate a mask image consistent with an original image in size;
A2: extracting a characteristic of the evaluated training image by using a first BiseNet_v2 network model; and
A3: calculating a loss function according to the characteristic and the mask image, training the first BiseNet_v2 network model through back propagation according to the loss function, and finally, obtaining the object semantic model.

Further, the place perception analysis includes the following steps:
B1: inputting all image data into a place perception discrimination model, and comparing the images in pairs until all images are compared more than ten times to obtain corresponding perception scores of all the images;
B2: acquiring numbers of times of each image with relatively high, low and same corresponding perception intensities (for example, safety) in comparison, and calculating perception intensity scores, where a calculation expression is as follows:

$${P}_{i} = \frac{{p}_{i}}{{p}_{i} + {e}_{i} + {n}_{i}} \\ {N}_{i} = \frac{{n}_{i}}{{p}_{i} + {e}_{i} + {n}_{i}} \\ {Q}_{i} = \frac{10}{3} \{ 2 {P}_{i} - {N}_{1} + 1 \}$$

where pᵢ represents the number of times of the i^{th} image with relatively high corresponding perception intensity (for example, safety) in comparison, nᵢ represents the number of times of the i^{th} image with relatively low corresponding perception intensity (for example, safety) in comparison, eᵢ represents the number of times of the i^{th} image with same corresponding perception intensity in comparison, and Qᵢ represents the perception intensity scores;
dividing the images into ten categories according to amplitudes of the perception intensity scores, each category comprising training set images and test set images, and calculating a perception intensity mean value and a perception intensity variance of each category of images;
B3: inputting the training set images and corresponding perception intensity scores into a perception intensity classification network for training, to obtain the trained perception intensity classification network; and
B4: inputting the test set images into the trained perception intensity classification network to obtain a probability of each category, multiplying the probability of each category with the perception intensity variance, then adding the result with the perception intensity mean value to obtain a perception score of each category, and performing weighted averaging of the perception scores of all categories to obtain the evaluated numerical value.

Further, a training process of the perception intensity classification network includes:
calculating a loss function numerical value of the network through a mean square error formula according to the images and the perception intensity scores; feeding back and adjusting the loss function numerical value through an optimizer, and when the loss function numerical value is the minimum, storing a current perception intensity classification network as the trained perception intensity classification network.

Further, an establishing process of each category of perception intensity (for example, safety) discrimination model includes:
acquiring safety discrimination values of the images, and inputting the images and the corresponding discrimination values into a neural network for training, to obtain the safety perception discrimination model.

Further, the data summary analysis module layers the data by using an Analytic Hierarchy Process (AHP) according to the sub-item index numerical value, acquires underlying standard data, then performs weighted calculation on data of each hierarchy according to an expert scoring result, and adds all calculated results to the underlying standard data to obtain the result data.

Further, the data summary analysis module calculates the sub-item index numerical value for received continuously distributed data by means of a spatial interpolation method in a natural domain, and calculates the sub-item index numerical value for received discretely distributed data by means of a kernel density calculation method.

Further, the audit result output module includes an index comparison sub module, a spatial evaluation sub module and a report inquiry sub module; and the index comparison sub module is configured to compare the result data in other areas, the spatial evaluation sub module is configured to exhibit a visualized effect in real time, and the report inquiry sub module can be used to examine a data diagram of the result data.

Compared with the prior art, the present invention has the advantages:

1. The present invention is provided with the data acquisition module, configured to acquire the urban streetscape image information and the visual urban road network data and urban point-of-interest data on the map, and is provided with the data classification auditing module to classy the images and process the image data by means of the data processing method to obtain different indexes of the urban streetscapes, the data summary analysis module calculates the corresponding result data, and finally, the audit result output module visualizes the result data. Compared with a conventional auditing method which observes and records by the auditors, the auditing efficiency is effectively improved, and a lot of data can be processed as well. According to different data processing methods, the auditing result is more accurate, so that the age-friendliness of the urban street is further improved.

2. In the present invention, the methods such as the object detection identification, object semantic segmentation, the place perception analysis and the geographic space data analysis method are used in the data classification auditing module to process the data; different identification methods are used for different indexes, and the images are inputted into different identification networks to obtain evaluated numerical values of the indexes of different types, so that the auditing result of the street is more diversified.

3. The data summary analysis module in the present invention calculates the evaluated numerical values through the Analytic Hierarchy Process (AHP) in combination with a scored result of an expert, layers the data and endows weights to the data, so that the result is more accurate.

### BRIEF DESCRIPTION OF THE DRAWINGS

FIG. 1 is a structural schematic diagram of a system of the present invention.

FIG. 2 is a schematic diagram where continuous data is processed in a data summary analysis module in the present invention.

FIG. 3 is a schematic diagram where discrete data is processed in the data summary analysis module in the present invention.

FIG. 4 is a schematic diagram where a spatial evaluation sub module is exhibited in the present invention.

FIG. 5 is a schematic diagram where an index comparison sub module is exhibited in the present invention.

FIG. 6 is a schematic diagram where an inquiry sub module is exhibited in the present invention.

### DESCRIPTION OF THE EMBODIMENTS

The present invention will be described in detail below in combination with drawings and specific embodiments. The embodiment is implemented based on the technical solution of the present invention, and detailed embodiments and specific operating processes are provided. But the protection scope of the present invention is not limited to the embodiments below.

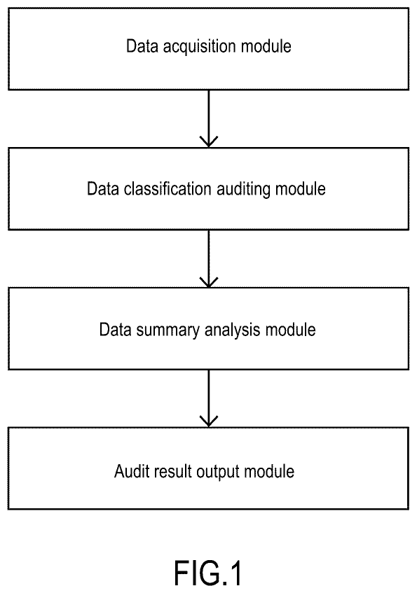

The embodiment provides an auditing system for a built environment of an age-friendly street based on multisource big data, as shown in FIG. 1, including a data acquisition module, a data classification auditing module, a data summary analysis module and an audit result output module, where
the data acquisition module is configured to acquire urban streetscape image data, urban road network data and urban point-of-interest data in a target range, wherein the urban streetscape image data comprises image data, where the urban streetscape image data is Baidu streetscape map data, a viewpoint height is a height of a streetscape vehicle device (about 2.3 m), a sight angle is a 15° elevation angle, image sizes are calculated as 600×480, a spacing of sampling points is 50 m, a distant view photograph at each sampling point is cut into 6 images, and front and back, and left and right photographs at 0°, 90°, 1800 and 270° are calculated. The urban road network data and the urban point-of-interest (POI) data are acquired from an open platform. A corresponding distribution relationship is shown in table 1:

TABLE 1
Corresponding tables of the urban streetscape image
data, the urban road network data and the urban
point-of-interest data in different cities

| | City A | City B | City C | City D |
|---|---|---|---|---|
| Area of | 1143.77 | 910.83 | 906.87 | 878.47 |
| region(km²) | | | | |
| Length of road | 10585.52 | 8484.07 | 10140.41 | 6080.46 |
| network (km) | | | | |
| Quantity of | 618580 | 1044044 | 766152 | 432856 |
| streetscape | | | | |
| images | | | | |
| Quantity of POI | 1704929 | 2122888 | 2055428 | 867070 |

The data classification auditing module is configured to acquire the data of the data acquisition module and classify the image data according to a four-layer classification module to acquire a classification result of the image data. The data classification auditing module is configured to acquire a data processing method according to the classification result look-up table and acquire evaluated numerical values of different types of indexes by means of the corresponding data processing method.

The four-layer classification module can be a Haar cascade classifier model or an OpenCV cascade classifier model. The four-layer classification types are respectively a first-hierarchy index, a second-hierarchy index, a third-hierarchy index, and a fourth-hierarchy index (with reference to table 2).

After the classification results are classified, there are totally four types of implementation technologies involved according to different specific classification results, which are respectively the object detection identification, the object semantic segmentation, the place perception analysis and geographic space data analysis. A corresponding relationship between specifically identified indexes and the used method is shown in table 2.

TABLE 2
Corresponding table for the evaluated numerical value type of the auditing index for the old and the data processing method

| First- | Second- | | | | | Evaluation | |
|---|---|---|---|---|---|---|---|
| hierarchy | hierarchy | Third-hierarchy | | | | Numerical | Data processing |
| index layer | index layer | index layer | | Identification element | | value type | method |
| A1 | B1 | C1 | Stable- | D1 | Prohibition and speed | Quantity | Object detection |
| Safety | Trip | | steady | | limit signs | | identification |
| | space | | level of | D2 | Deceleration strip | Quantity | Object semantic |
| | safety | | motorized | | | | segmentation |
| | | | traffic | | | | |
| | | C2 | Walking | D3 | Sidewalk | Sequence | Object semantic |
| | | | safety | | | degree | segmentation + geographic |
| | | | level | | | | space data analysis |
| | | | | D4 | Sidewalk | Quality | Place perception |
| | | | | | | | analysis |
| | | C3 | Riding | D5 | Non-motorized vehicle | Sequence | Object semantic |
| | | | safety | | lane | degree | segmentation + geographic |
| | | | level | | | | space data analysis |
| | | | | D6 | Non-motorized vehicle | Quality | Place perception |
| | | | | | lane | | analysis |
| | | C4 | Crossing | D7 | Pedestrian crossing | Quantity | Object semantic |
| | | | safety | | | | segmentation |
| | | | level | D8 | Traffic light | Quantity | Object detection |
| | | | | | | | identification |
| | B2 | C5 | Safety | D9 | Road separation facility | Quantity | Object semantic |
| | Subsidiary | | level of | | | | segmentation |
| | facility | | separation | D10 | Road separation facility | Quality | Place perception |
| | safety | | facility | | | | analysis |
| | | C6 | Safety | D11 | Road sign | Quality | Place perception |
| | | | level of | | | | analysis |
| | | | traffic | D12 | Pay attention to | Quantity | Object detection |
| | | | sign | | pedestrian sign | | identification |
| | | | | D13 | Pedestrian crossing | Quantity | Object detection |
| | | | | | sign | | identification |
| | | C7 | Safety | D14 | Curb ramp | Quantity | Object detection |
| | | | level of | | | | identification |
| | | | barrier- | D15 | Barrier-free ramp at | Quantity | Object detection |
| | | | free | | exit and entrance | | identification |
| | | | facility | D16 | Lighting facility (street | Quantity | Object detection |
| | | | | | lamp) | | identification |
| | | C8 | Hidden | D17 | Box substation | Quantity | Object detection |
| | | | dangers | | | | identification |
| | | | of other | D18 | Air conditioner outdoor | Quantity | Object detection |
| | | | subsidiary | | unit | | identification |
| | | | facilities | D19 | Pole and junction box | Quantity | Object detection |
| | | | | | | | identification |
| A2 | B3 | C9 | Clean | D20 | Clean level of sidewalk | Clean level | Place perception |
| Health | Promote a | | level of | | | | analysis |
| | material | | trip space | D21 | Non-motorized vehicle | Clean level | Place perception |
| | space | | | | lane | | analysis |
| | environment | | | D22 | Clean level of activity | Clean level | Place perception |
| | of health | | | | space | | analysis |
| | of the old | C10 | Greening | D23 | Street vegetation | Area | Object semantic |
| | | | level of | | | | segmentation |
| | | | street | D24 | Street vegetation | Type | Object semantic |
| | | | | | | quantity | segmentation |
| | B4 | C11 | Positive | D25 | Sidewalk | Area | Object semantic |
| | Promote a | | trip level | | | | segmentation |
| | social | | | D26 | Non-motorized vehicle | Area | Object semantic |
| | activity | | | | lane | | segmentation |
| | environment | C12 | Level | D27 | Activity place of street | Quantity | Object detection |
| | of health | | supported | | | | identification |
| | of the old | | by | D28 | Activity place of street | Safety | Place perception |
| | | | resident | | | | analysis |
| | | | activity | D29 | Step in activity place of | Quantity | Object semantic |
| | | | place | | street | | segmentation |
| | | C13 | Level | D30 | Public artistic facility | Quantity | Object detection |
| | | | supported | | (sculpture) | | identification |
| | | | by | D31 | Rest facility (seat) | Quantity | Object detection |
| | | | resident | | | | identification |
| | | | activity | D32 | Fitness facility | Quantity | Object detection |
| | | | facility | | | | identification |
| | | | | D33 | Street facility type | Quantity | Object detection |
| | | | | | | | identification |
| A3 | B5 | C14 | Diverse | D34 | Commercial facility | Quantity | Geographic space data |
| Convenience | Diversity | | level of | | | | analysis |
| | of public | | life | D35 | Cultural facilities | Quantity | Geographic space data |
| | service | | service | | | | analysis |
| | facilities | | facilities | D36 | Medical facilities | Quantity | Geographic space data |
| | | | | | | | analysis |
| | | | | D37 | Bus transfer facilities | Quantity | Geographic space data |
| | | | | | | | analysis |
| | | C15 | Diverse | D38 | Sports facilities | Quantity | Geographic space data |
| | | | level of | | | | analysis |
| | | | recreational | D39 | Park plaza | Quantity | Geographic space data |
| | | | sports | | | | analysis |
| | | | facilities | | | | |
| | B6 | C16 | Convenience | D40 | Total quantity of public | Quantity | Geographic space data |
| | Convenience | | level of | | service facilities | | analysis |
| | of special | | integral | D41 | Proportion of total | Quantity | Geographic space data |
| | service | | facilities | | quantity of special | | analysis |
| | facilities | | | | facilities for the old | | |
| | for the old | C17 | Convenience | D42 | Teaching facilities for | Quantity | Geographic space data |
| | | | level of | | the old | | analysis |
| | | | classified | D43 | Welfare facilities for | Quantity | Geographic space data |
| | | | facilities | | the old | | analysis |
| | | | | D44 | Non-barrier health | Quantity | Geographic space data |
| | | | | | facilities | | analysis |
| A4 | B7 | C18 | Comfort | D45 | Arbor shade of street | Area | Object semantic |
| Comfort | Trip | | level of | | | | segmentation |
| | comfort | | trip | D46 | Shading facilities | Quantity | Object detection |
| | | | environment | | | | identification |
| | | C19 | Comfort | D47 | Shading facilities of | Quantity | Object detection |
| | | | level of | | bus stops | | identification |
| | | | bus stops | D48 | Seats at bus stops | Quantity | Object detection |
| | | | | | | | identification |
| | B8 | C20 | Interface | D49 | Aesthetic degree of the | Aesthetic | Place perception |
| | Environmental | | attraction | | interface along the | perception | analysis |
| | pleasurableness | | level | | street | | |
| | | | | D50 | Vitality of the interface | Sense of | Place perception |
| | | | | | along the street | vitality | analysis |
| | | | | D51 | Favor degree of the old | Favor degree | Place perception |
| | | | | | for the interface along | | analysis |
| | | | | | the street | | |
| | | C21 | Visual | D52 | Sky | Proportion | Object semantic |
| | | | open | | | | segmentation |
| | | | level | D53 | Depth-width ratio of | Depth-width | Object semantic |
| | | | | | the street | ratio | segmentation |

The step of object detection and identification includes: inputting an image into an object detection model to obtain an evaluated numerical value. Each of the evaluated numerical values corresponds to a special object detection model, and the major difference lies in different calibration information used during training. A method for establishing the object detection model includes:

S1: acquiring an evaluated training image with the calibrated evaluation information, for example, if the object detection model which evaluates the quantity of the traffic lights is established, the calibrated evaluation information is the quantity of the traffic lights in the image, pre-processing the calibrated evaluation information, and converting the calibration information into a special format text file.

S2: using a first YOLOv5 network model, where a YOLOv5 network model architecture includes four portions:
an input end represents an image inputted, where the size of the inputted image of the network is 608*608, an image pre-processing stage is included, that is, the inputted image is zoomed to the size inputted to the network and is subjected to operations such as normalization; a Mosaic data enhancing operation is used to improve the training speed of the model and the precision of the network.
a baseline network is usually a network in some classifiers with excellent performance, and the module is configured to extract some universal characteristics; not only a CSPDarknet53 structure, but also a Focus structure are used as the baseline network.
a Neck network further enhances the diversity and robustness of the characteristics.
a Head output end is configured to finish outputting of the characteristics.

S3: calculating a loss function according to the characteristic and the pre-processed calibrated evaluation information, training the first YOLOv5 network model through back propagation according to the loss function, and finally, obtaining the object detection model.

The step of object semantic segmentation includes: inputting an image into an object detection model to obtain an evaluated numerical value. Each of the evaluated numerical values corresponds to a special object semantic segmentation model, and the major difference lies in different calibration information used during training. A method for establishing the object semantic model includes:

A1: acquiring an evaluated training image with calibrated evaluation information to generate a mask image consistent with an original image in size, that is, a background image with pixels being 1.

A2: extracting a characteristic of the evaluated training image by using a first BiseNet_v2 network model, where the BiseNet v2 is a network architecture considering both low-level details and high-level semantics.

A3: calculating a loss function according to the characteristic and the mask image, training the first BiseNet_v2 network model through back propagation according to the loss function, and finally, obtaining the object semantic model.

The loss function is a joint loss function, where a main loss function is configured to supervise training of the model, an assistant loss function is configured to supervise training of Context Pat, and all loss functions are Softmax functions. An expression of the final loss function L is as follows:

$$L ( X ; W ) = {L}_{p} ( X ; W ) + ∝ {\sum }_{i = 2}^{3} {L}_{i} ( Xi ; W )$$

where X represents a predicted value of the loss function, W represents a target value of the loss function, L_{P} represents the main loss function, Lᵢ represents the assistant loss function in different stages, Xi represents an output of an i^{th} stage of Xception, and ∝ is 0.5.

The place perception analysis includes the following steps:

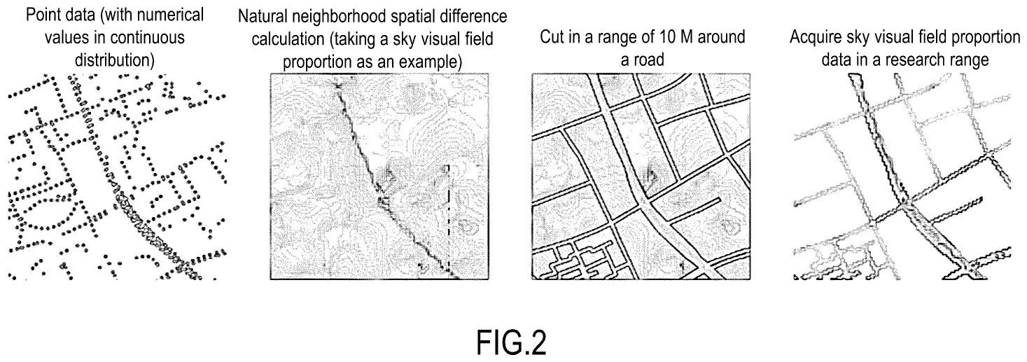

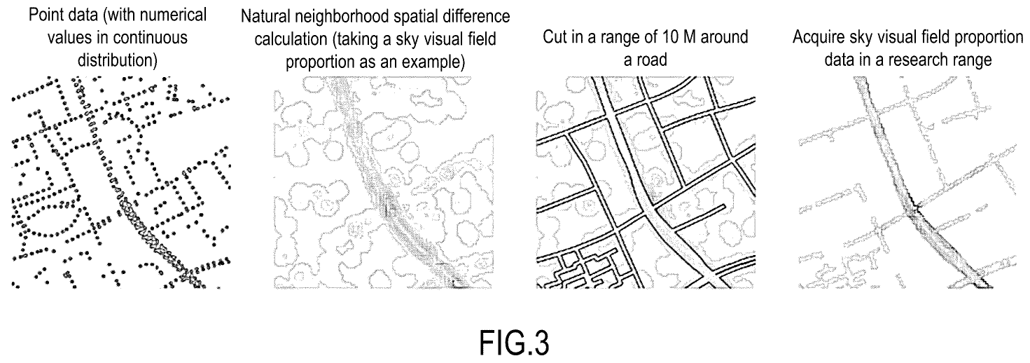

B1: inputting all image data into a place perception (for example, safety) discrimination model to obtain amplitudes of safety of all images, and comparing the images in pairs until all images are compared more than ten times to obtain corresponding perception scores of all the images.
a method for establishing the safety discrimination model includes:
first, putting in over 2000 questionnaires, including urban street images, where items being safety discrimination values with scores from 1 to 10, and inputting the images and the safety discrimination values as the training images and the training tags of the safety discrimination model into a neural network to be trained to obtain the safety discrimination model.
the safety for place perception analysis is taken as an example herein; according to FIG. 2 and FIG. 3, the questionnaires further include contents such as clean level and interest, that is, the questionnaires will also include the discrimination model of other parameters and corresponding outputted results, which will not be repeatedly described in the embodiment.

B2: acquiring numbers of times of each image with relatively high, low and same safety in comparison, and calculating perception intensity scores, where a calculation expression is as follows:

$${P}_{i} = \frac{{p}_{i}}{{p}_{i} + {e}_{i} + {n}_{i}} \\ {N}_{i} = \frac{{n}_{i}}{{p}_{i} + {e}_{i} + {n}_{i}} \\ {Q}_{i} = \frac{10}{3} \{ 2 {P}_{i} - {N}_{1} + 1 \}$$

where pᵢ represents the number of times of the i^{th} image with relatively high safety in comparison, nᵢ represents the number of times of the i^{th} image with relatively small safety in comparison, eᵢ represents the number of times of the i^{th} image with same safety in comparison, and Qᵢ represents the perception intensity scores, an interval of a value of which is 0-10;
dividing the images into ten categories according to amplitudes of the perception intensity scores, each category including no fewer than 300 images and training set images and test set images at a proportion of 8: 2, and calculating a perception intensity mean value and a perception intensity variance of each category of images;

B3: in the embodiment, training the training set images in batches in a PyTorch deep learning frame with DenseNet, first, establishing a perception intensity classification network, putting the images and perception intensity scores corresponding to the same into the network to be trained, and calculating a loss function value of the network through a mean square error equation:
performing forward feeding through an optimizer and adjusting a network, recalculating the loss function value, where the loss function is gradually decreased to the minimum, storing the perception intensity classification network when the loss function is minimum, calculating a topk accuracy of the model, and repeating the step to adjust a learning rate, the loss function and a batch size parameter until the topk accuracy meets conditions that top1>30% and top3>80%, so as to obtain the trained perception intensity classification network,
where topk represents an accuracy algorithm, for example, top1 refers to a probability that the classification outputted with the maximum probability is identical to the actual classification when the tested images are inputted into the perception intensity classification network; and top3 refers to a probability that there is at least one predicted classification is identical to the actual classification in the top three classifications outputted;

B4: inputting the test set images into the trained perception intensity classification network to obtain a probability of each category, multiplying the probability of each category with the perception intensity variance, then adding the result with the perception intensity mean value to obtain a perception score of each category, and performing weighted averaging of the perception scores of all categories to obtain the evaluated numerical value.

Geographic space data analysis is the prior art, which is not described repeatedly in the embodiment.

The data summary analysis module is configured to acquire the evaluated numerical values of the data classification auditing module, calculate sub-item index numerical values of each output unit and calculate result data according to the sub-item index numerical values. A specific calculation method is as follows:

First, in the evaluated numerical values, there exist point data such as quantity in discrete distribution, and there also exist point data such as safety in continuous distribution, so that sub-item index numerical values are calculated with different methods. For the point data with numerical values in continuous distribution, a natural neighborhood spatial interpolation method is adopted to calculate the sub-item index numerical values in each outputted unit (10 m*10 m pixels); for the point data with numerical values in discrete distribution, the sub-item index numerical values in each outputted unit are calculated. A specific calculation process is shown in FIG. 2 and FIG. 3.

After the sub-item index numerical values are calculated, the data is layered by way of a stacked mode of AHP, first, bottom standard data is calculated, and then a weight of each hierarchy is acquired through an expert scoring result, indexes of all hierarchies are successively subjected to weighted stacking to calculate the result data. The result data is recorded in a geographic space information system for summarization to form a characteristic database of an urban age-friendly built environment.

The expert scoring result is a current scoring result.

The audit result output module includes an index comparison sub module, a spatial evaluation sub module and a report inquiry sub module and provides functions such as result inquiry, problem diagnosis, promotional proposal of the age-friendly street, where the index comparison sub module is configured to compare the result data in other areas, the spatial evaluation sub module is configured to exhibit a visualized effect on a map in real time in combination with the urban road network data and the urban point-of-interest data, so that the data is more intuitive, and the inquiry sub module can be used to examine a data diagram of the result data, download the problem diagnosis and report the promotional proposal.

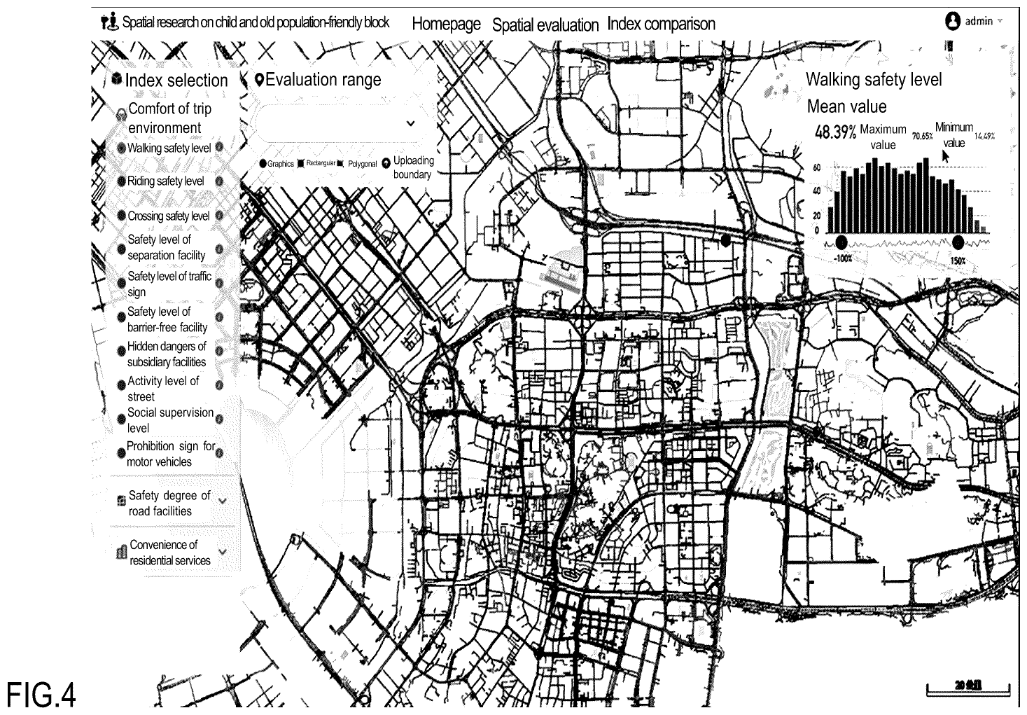

A specific actual utilization graph of the audit result output module is shown in FIGS. 4-6. It can be known according to FIG. 4, a left column of the spatial evaluation sub module on the left side of the map is selection of indexes. By selecting the index type, corresponding result data of the indexes at specific positions of the map can be seen, and moreover, an analysis result for the result data will be displayed on the right side.

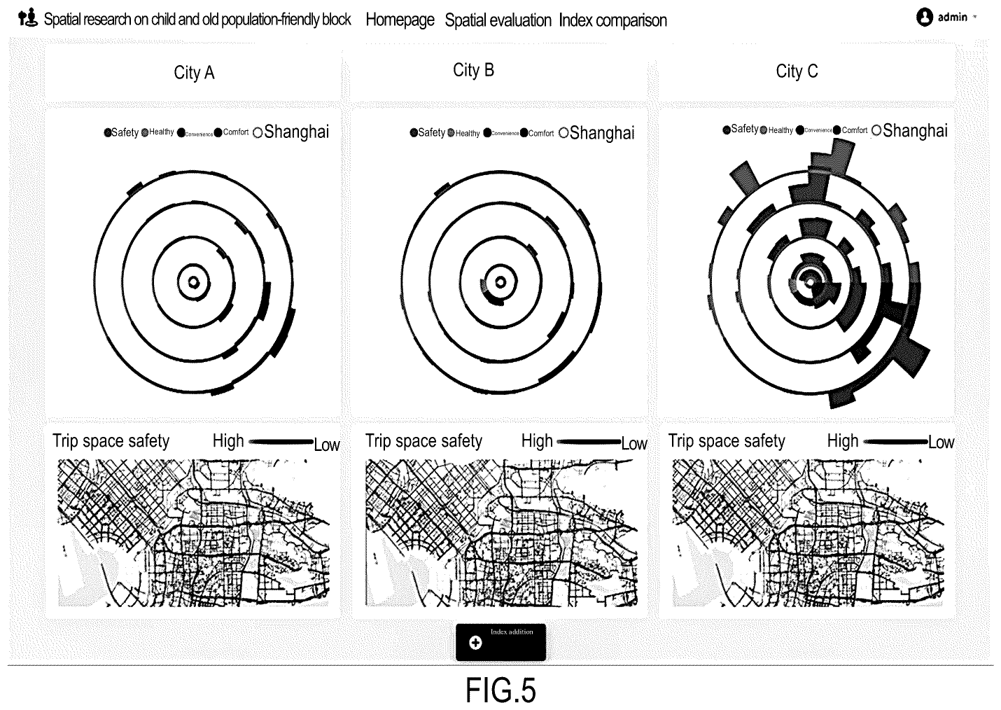

It can be known according to FIG. 5, the index comparison sub module can exhibit results of different indexes through a radar map, and a schematic diagram of different indexes of three cities is shown here.

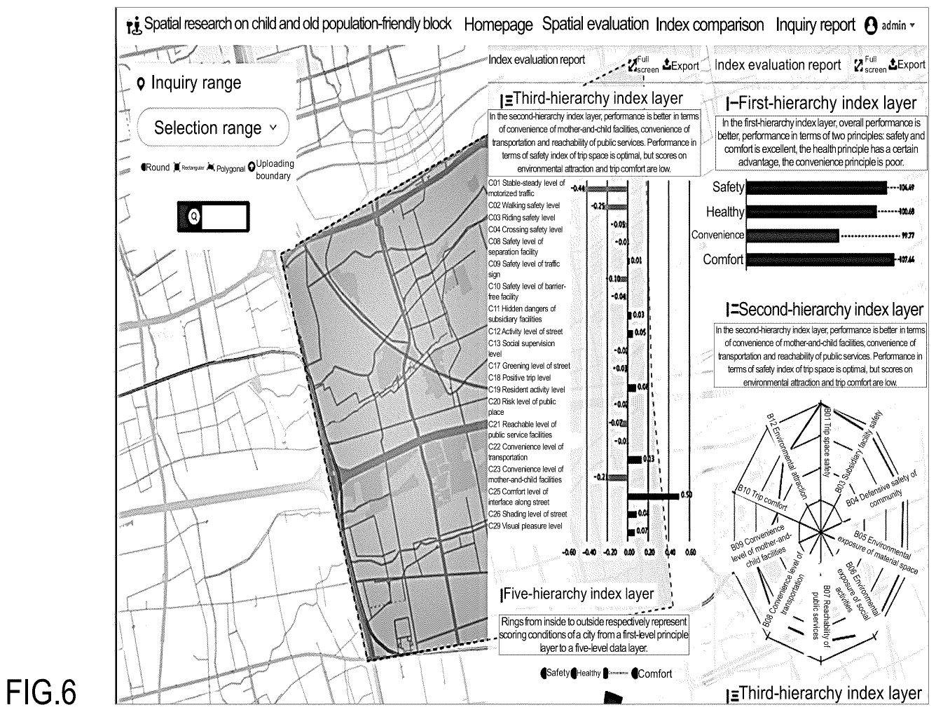

It can be known according to FIG. 6, the inquiry sub module selects different data graphs to show the data for different index layers, and can directly select an inquiry range to acquire information.

The embodiment further includes an auditing device for a built environment of an age-friendly street based on multisource big data, including a memory and a processor, where the memory stores the auditing system for a built environment of an age-friendly street based on multisource big data, and the processor calls the system in the memory to run, so as to complete audit of the built environment of the age-friendly street.

The preferred specific embodiments of the present invention are described in detail above. It should be understood that those of ordinary skill in the art can make various modifications and variations in accordance with concept of the present invention without creative efforts. Therefore, technical solutions capable of being obtained by technicians in the technical field through logical analysis, inference or limited experiments in accordance with concept of the present invention based on the prior art shall fall into the scope of protection determined by claims.

To the claims:

1. An auditing system for a built environment of an age-friendly street based on multisource big data, comprising a data acquisition module, a data classification auditing module, a data summary analysis module and an audit result output module, wherein
the data acquisition module is configured to acquire urban streetscape image data, urban road network data and urban point-of-interest data in a target range, wherein the urban streetscape image data comprises image data;
the data classification auditing module is configured to acquire the data of the data acquisition module, classify the image data, and process the image data by using a data processing method acquired by a look-up table according to a classification result look-up table to acquire evaluated numerical values of different types of indexes;
the data summary analysis module is configured to acquire the evaluated numerical values of the data classification auditing module, calculate sub-item index numerical values of each output unit and calculate result data according to the sub-item index numerical values; and
the audit result output module is configured to acquire the result data of the data summary analysis module and visualize and output the result data in combination with the urban road network data and the urban point-of-interest data.

2. The auditing system for a built environment of an age-friendly street based on multisource big data according to claim 1, wherein after acquiring the image data, the data classification auditing module classifies the image data according to a four-layer classification module to acquire a classification result of the image data, and acquires a data processing method corresponding to the image in combination with an existing auditing index classification table according to the classification result.

3. The auditing system for a built environment of an age-friendly street based on multisource big data according to claim 1, wherein the data processing method of the data classification auditing module comprises object detection and identification, object semantic segmentation, place perception analysis and geographic space data analysis.

4. The auditing system for a built environment of an age-friendly street based on multisource big data according to claim 3, wherein the object detection and identification comprises: inputting an image into an object detection model to obtain an evaluated numerical value; and
a training process of the object detection model comprises:
S1: acquiring an evaluated training image with calibrated evaluation information and pre-processing the calibrated evaluation information;
S2: extracting a characteristic of the evaluated training image by using a first YOLOv5 network model; and
S3: calculating a loss function according to the characteristic and the pre-processed calibrated evaluation information, training the first YOLOv5 network model through back propagation according to the loss function, and finally, obtaining the object detection model.

5. The auditing system for a built environment of an age-friendly street based on multisource big data according to claim 3, wherein the object semantic segmentation comprises: inputting an image into an object semantic model to obtain an evaluated numerical value; and
a training process of the object semantic model comprises:
A1: acquiring an evaluated training image with calibrated evaluation information to generate a mask image consistent with an original image in size;
A2: extracting a characteristic of the evaluated training image by using a first BiseNet_v2 network model; and
A3: calculating a loss function according to the characteristic and the mask image, training the first BiseNet_v2 network model through back propagation according to the loss function, and finally, obtaining the object semantic model.

6. The auditing system for a built environment of an age-friendly street based on multisource big data according to claim 3, wherein the place perception analysis comprises the following steps:
B1: inputting all image data into a place perception discrimination model, and comparing the images in pairs until all images are compared more than ten times to obtain corresponding perception scores of all the images;
B2: acquiring numbers of times of each image with relatively high, low and same corresponding perception intensities in comparison, and calculating perception intensity scores, wherein a calculation expression is as follows:
$${P}_{i} = \frac{{p}_{i}}{{p}_{i} + {e}_{i} + {n}_{i}} \\ {N}_{i} = \frac{{n}_{i}}{{p}_{i} + {e}_{i} + {n}_{i}} \\ {Q}_{i} = \frac{10}{3} \{ 2 {P}_{i} - {N}_{1} + 1 \}$$
where pᵢ represents the number of times of the i^{th} image with relatively high corresponding perception intensity in comparison, nᵢ represents the number of times of the i^{th} image with relatively low corresponding perception intensity in comparison, eᵢ represents the number of times of the i^{th} image with same corresponding perception intensity in comparison, and Qᵢ represents the perception intensity scores;
dividing the images into ten categories according to amplitudes of the perception intensity scores, each category comprising training set images and test set images, and calculating a perception intensity mean value and a perception intensity variance of each category of images;
B3: inputting the training set images and corresponding perception intensity scores into a perception intensity classification network for training, to obtain the trained perception intensity classification network; and
B4: inputting the test set images into the trained perception intensity classification network to obtain a probability of each category, multiplying the probability of each category with the perception intensity variance, then adding the result with the perception intensity mean value to obtain a perception score of each category, and performing weighted averaging of the perception scores of all categories to obtain the evaluated numerical value.

7. The auditing system for a built environment of an age-friendly street based on multisource big data according to claim 6, wherein a training process of the perception intensity classification network comprises:
calculating a loss function numerical value of the network through a mean square error formula according to the images and the perception intensity scores; feeding back and adjusting the loss function numerical value through an optimizer, and when the loss function numerical value is the minimum, storing a current perception intensity classification network as the trained perception intensity classification network.

8. The auditing system for a built environment of an age-friendly street based on multisource big data according to claim 6, wherein an establishing process of each category of place perception discrimination model comprises:
acquiring corresponding place perception discrimination values of the images, and inputting the images and the corresponding place perception discrimination values of the images into a neural network for training, to obtain each category of place perception discrimination model.

9. The auditing system for a built environment of an age-friendly street based on multisource big data according to claim 1, wherein the data summary analysis module calculates the sub-item index numerical value for received continuously distributed data by means of a spatial interpolation method in a natural domain, and calculates the sub-item index numerical value for received discretely distributed data by means of a kernel density calculation method.

10. The auditing system for a built environment of an age-friendly street based on multisource big data according to claim 1, wherein the data summary analysis module layers the data by using an Analytic Hierarchy Process (AHP) according to the sub-item index numerical value, acquires underlying standard data, then performs weighted calculation on data of each hierarchy according to an expert scoring result, and adds all calculated results to the underlying standard data to obtain the result data.

11. The auditing system for a built environment of an age-friendly street based on multisource big data according to claim 1, wherein the audit result output module comprises an index comparison sub module, a spatial evaluation sub module and a report inquiry sub module, wherein the index comparison sub module is configured to compare the result data in other areas, the spatial evaluation sub module is configured to exhibit a visualized effect in real time, and the report inquiry sub module can be used to examine a data diagram of the result data.
